(19) United States
(12) Patent Application Publication
(10) Pub. No.: US 2007/0014306 A1
(43) Pub. Date: Jan. 18, 2007

(54) Remote digital subscriber line access multiplexer

(76) Inventor: Tomi Tirri, Espoo (FI)

Correspondence Address: ARENT FOX PLLC, 1050 CONNECTICUT AVENUE, N.W., SUITE 400, WASHINGTON, DC, 20036, US

(21) Appl. No.: 10/546,194

(22) PCT Filed: Feb. 19, 2003
(86) PCT No.: PCT/FI03/00123

§ 371 Date: Aug. 18, 2006

(51) Int. Cl. H04L 12/66; H04J 3/04

(52) U.S. Cl. 370/463; 370/535

(57) ABSTRACT

The present invention relates to a remote digital subscriber line access multiplexer (DSLAM), and to DSL systems providing data network services to customers. The remote DSLAM has at least two high data rate connections, from which one of the high data rate connections is an optical connection and another one of the high data rate connections is an electrical connection. Alternatively, the connections may be of the same type. The remote DSLAM also comprises a lower data rate connection(s), which is preferably a twisted-pair copper line connection. The remote DSLAM is connected to a central office, a data network node, or another remote DSLAM. The connection to the central office is preferably an optical connection, the connection to the data network node is preferably an electrical connection, and the connection to another remote DSLAM may be an optical, an electrical, or a twisted-pair copper line connection.

### TECHNICAL FIELD OF THE INVENTION

The present invention relates to DSL systems, and more particularly to remote DSLAMs (Digital Subscriber Line Access Multiplexers), their connections, and a system for connecting DSLAMs to each other.

### BACKGROUND OF THE INVENTION

The most used method for transmitting and receiving (in the user's end) data is a voice grade data modem. The capacity for transmitting and receiving the data of the voice grade data modem over a common telephone line is presently up to 56 kbps. This transmit speed does not satisfy the needs of the present day services that are provided e.g., through the Internet. For providing data on a higher transmission data rate, there is provided various solutions that utilize the existing twisted-pair copper telephone lines.

The most commonly used solution for transmitting the data on a higher transmission data rate is based on ADSL (Asynchronous Digital Subscriber Line) technology. Even though the present ADSL technology is capable for the transmission data rate up to 9.0 Mbps for downstream and 640 kbps for upstream, the transmission data rate is not sufficient for so called full service network. The full service network includes services e.g., HDTV (High Definition Television), which demands the transmission data rate (HDTV demands as much as 20 Mbps data rate) higher than the ADSL technology is capable of providing. Also when the number of subscribers increases, the need for transmission data rates provided by ADSL technology may become insufficient.

One solution for providing the transmission data rates sufficient for the full service networks is VDSL (Very high data rate Digital Subscriber Line) technology. VDSL technology can provide transmission data rates up to 52 Mbps for downstream and upstream totally. Both asymmetric and symmetric transmission data rates are possible. Although, VDSL provides higher transmission data rates than ADSL, it provides them over shorter lines. For example, for a transmission data rate of 52 Mbps the twisted-pair copper telephone line length is only about 300 meters, and for a transmission data rate of 13 Mbps the twisted-pair copper telephone line length is about 1500 meters. Both downstream and upstream channels can be separated in frequency from bands used for both POTS (Plain Old Telephone Service) and ISDN (Integrated Services Digital Network), enabling service providers to overlay VDSL on existing services.

Since the transmission data rates drops rapidly when the length of the twisted-pair copper telephone line is extended, there are suggested solutions for providing higher transmission data rates for subscribers situated over 1500 meters from the central office (CO) of the DSL service provider.

One of the suggested solutions is so called Fiber to the Cabinet, in which there is provided a fiber connection (having a transmission data rate of 1 Gbps) between the CO and a street cabinet (having a DSLAM in the street cabinet) and twisted-pair copper telephone line connections between the street cabinet and the subscribers. This solution provides a possibility to bring the high data rate connections to more distant subscribers, but the investments requires quite a lot of money especially when the existing twisted-pair copper telephone lines should be replaced by the fiber. Also the number of possible subscribers is limited to the number of possible connections provided by the DSLAM in the street cabinet. When new subscribers should be added to the system, the size (i.e., the number of the DSL modem cards) of the street cabinet DSLAM should be increased. Alternatively, another street cabinet DSLAM and new fiber connection between the Co and the street cabinet DSLAM should be installed.

One solution for decreasing the attenuation, and thereby improving the transmission capacity to more distant subscribers over the twisted-pair copper telephone lines, caused by the twisted-pair copper telephone line length features is to use repeaters. This solution, however, is not preferable, because of the rapid decrease of the transmission data rate (especially when the DSL service provider wishes to provide the full service transmission data rates for the subscribers) and they are essentially difficult to install. Due to the need of numerous repeaters in the twisted-pair copper telephone line, the costs of the investment increases tremendously especially on the areas where the subscribers are situated at relatively long distance from each other.

Even though there has been described various solutions for providing higher transmission data rates to more distant customers, the solutions have high set up costs for a service provider, they are rigid for adjusting to the number of subscribers, and/or they require the existing twisted-pair copper telephone lines to be replaced by new fiber lines (providing higher data transmission capacity).

### SUMMARY OF THE PRESENT INVENTION

It is an object of the present invention to overcome or at least mitigate the disadvantages of the prior art. The present invention provides a remote digital subscriber line access multiplexer (DSLAM) and DSL systems for providing data network services to customers

It is an object of the present invention to provide a solution for connecting DSLAMs to each other efficiently.

Further, it is an object of the present invention to provide a solution to adjust the number of customer connections in a flexible manner.

According to a first aspect of the present invention, there is provided a remote digital subscriber line access multiplexer (DSLAM) comprising:

means for connecting the remote DSLAM to a device through a first connection;

means for processing received data in the remote DSLAM; and

means for connecting the remote DSLAM to a DSLAM through a second connection.

Preferably, the remote DSLAM further comprises a third connection for connecting to a remote DSLAM.

Preferably, the device is a central office, a data network node, another remote DSLAM, or a customer premises equipment, the DSLAM is a remote DSLAM, and means for processing the received data comprises a switch, a CPU (Central Processing Unit), and a DSL chipset.

Preferably, the first and the third connections are high data rate connections, which are optical connections or electrical connections, and the second connection is a twisted-pair copper telephone line connection, an optical connection, or an electrical connection.

According to a second aspect of the present invention, there is provided a DSL (Digital Subscriber Line) system providing data network services to customers, the DSL system comprising:

a central office;

a first remote DSLAM (Digital Subscriber Line Access Multiplexer) connected to the central office via a first high data rate connection;

a second remote DSLAM connected to the first remote DSLAM via a second high data rate connection or lower data rate connection.

Preferably, the first high data rate connection is an optical connection, the second high data rate connection is an optical connection or an electrical connection, and the lower data rate connection is a twisted-pair copper telephone line connection.

Preferably, the second remote DSLAM is further connected to a third remote DSLAM via an optical connection, an electrical connection, or a twisted-pair copper telephone line connection, and the first remote DSLAM and the second remote DSLAM provides data to customers via twisted-pair copper telephone line connection.

According to a third aspect of the present invention, there is provided a DSL (Digital Subscriber Line) system providing data network services to customers, the DSL system comprising:

a data network node;

a first remote DSLAM (Digital Subscriber Line Access Multiplexer) connected to the data network node via a first high data rate connection;

a second remote DSLAM connected to the first remote DSLAM via a second high data rate connection or lower data rate connection

Preferably, the first high data rate connection is an electrical connection, the second high data rate connection is an optical connection or an electrical connection, and the lower data rate connection is a twisted-pair copper telephone line connection.

Preferably, the second remote DSLAM is further connected to a third remote DSLAM via an optical connection, an electrical connection, or a twisted-pair copper telephone line connection.

Preferably, the data network node is a router.

The present invention provides various advantages over the prior art solutions. The system of the present invention is capable of providing DSL services to new customers more cost efficient manner than the prior art solutions, by connecting a remote DSLAM via high data rate connection or lower data rate connection to existing DSLAM (which is essentially close to the customers). This approach also provides flexibility to the number of the customers of the DSL services.

### BRIEF DESCRIPTION OF THE DRAWINGS

For a better understanding of the present invention and in order to show how the same may be carried into effect reference will now be made to the accompanying drawings, in which:

FIG. 1 shows a general presentation of part of a network implementing VDSL principles.

FIG. 2 shows a remote DSLAM (Digital Subscriber Line Access Multiplexer) according to the present invention.

FIG. 3 shows an embodiment of the present invention, in which two remote DSLAMs are connected to each other via high data rate connection.

FIG. 4 shows an embodiment of the present invention, in which two remote DSLAMs are connected to each other via lower data rate connection.

FIG. 5 shows one embodiment of the present invention.

### DETAILED DESCRIPTION OF CERTAIN EMBODIMENTS

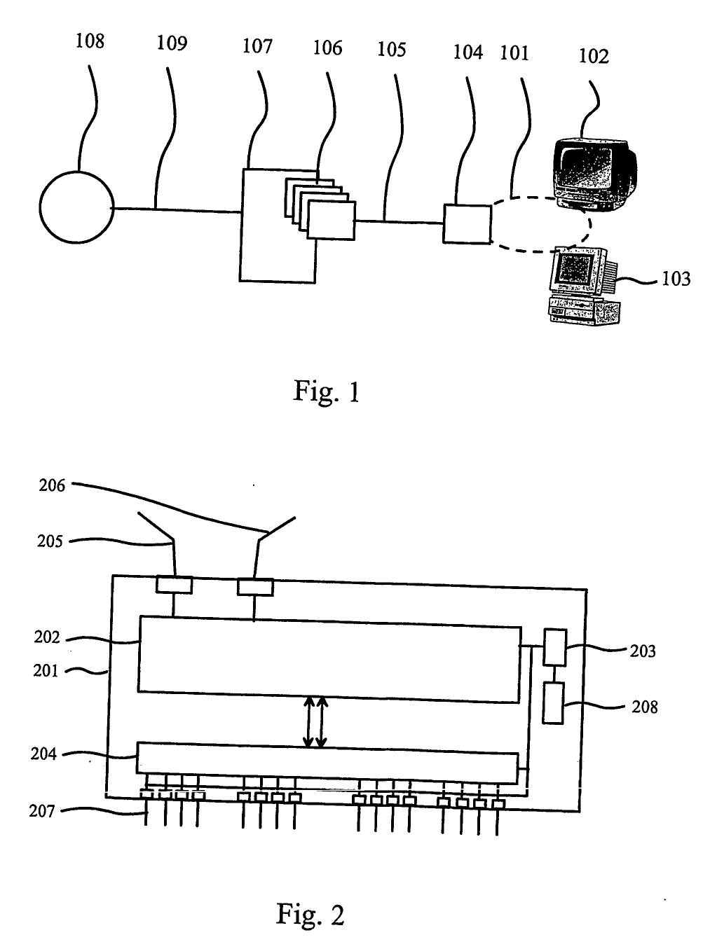

FIG. 1 shows a general presentation of part of a network implementing VDSL principles. In FIG. 1, there is shown a premises distribution network 101 comprising a television 102 and a PC (Personal Computer) 103. The premises distribution network 101 is connected to a customer premises VDSL modem 104, which provides the transformation of data from a digital form to an analog form and vice versa, located in the premises.

Since VDSL system must transmit compressed video (a real time signal unsuited to error retransmission schemes used in data communications), VDSL system have to incorporate Forward Error Correction (FEC) with sufficient interleaving to correct all errors created by impulsive noise events of some specified duration in order to achieve error rates compatible with compressed video.

The customer premises VDSL modem 104 is connected through a twisted-pair copper telephone line 105 to one of VDSL modems 106 in an Optical Network Unit (ONU) (or a remote DSLAM) 107. The ONU VDSL modem 106 converts an analog signal, received from the customer premises VDSL modem 104 through the twisted-pair copper telephone line 105, into a digital form, and from the digital signal, that is transmitted to the customer premises VDSL modem 104, into the analog form. ONU 107 has several VDSL modems 106 to collect the traffic coming from different VDSL users, each having VDSL modem 104.

The transmitted and received signals are separated using Frequency Division Multiplexing (FDM). The transmitted and received signals are thus in the different frequency ranges (or bands). The signals can be limited in certain band using bandpass filters, i.e., they let some frequencies go through and stop the other frequencies.

Downstream, i.e., a data stream from the ONU VDSL modem 106 to the customer premises VDSL modem 104, and upstream, i.e., a data stream from the customer premises VDSL modem 104 to the ONU VDSL modem 106, is totally 52 Mbps in the best case, depending on the twisted-pair copper telephone line length.

The ONU 107 is connected to a core network 108 through a fiber cable 109, having an optical connection with considerably faster data rate than the twisted-pair copper telephone line 105. The optical connection between the core network 108 and the ONU 107 may be implemented according to different possibilities defined in SDH (Synchronous Digital Hierarchy) standards, and/or in DWDM (Dense Wavelength Division Multiplexing) standards.

FIG. 2 shows a remote DSLAM (Digital Subscriber Line Access Multiplexer) 201, which may be installed e.g., at a street cabinet, a pole, a manhole or alike, according to the present invention. In FIG. 2, there is shown the key elements of the remote DSLAM and the uplink and downlink connections to other devices (e.g., central office, a data network node, and/or customer premises equipment). Hardware key elements of the remote DSLAM are a switch 202 for packet forwarding, a CPU (Central Processing Unit) 203 for upkeeping (or managing) functions and a VDSL chipset 204 for VDSL lines. The connections shown in FIG. 2 are: a first high data rate (or speed) uplink connection 205, a second high data rate uplink connection 206, and multiple lower data rate connections (VDSL lines) 207. The switch 202, the CPU 203, the VDSL chipset 204, and a memory 208 form the processing means (or means for processing) of the remote DSLAM 201. Further, the remote DSLAM 201 comprises a suitable power supply (not shown).

In the preferred embodiment of the present invention, the first high data rate connection 205 is an optical connection capable of a transmission data rate of Gbit to and from the remote DSLAM 201. The first high data rate connection 205 is a connection between the remote DSLAM 201 and a central office (not shown) of the service provider. Alternatively, the first high data rate connection is a connection between the remote DSLAM 201 and another remote DSLAM (not shown).

In the preferred embodiment of the present invention, the second high data rate connection 206 is an electrical connection capable of a transmission data rate of Gbit to and from the remote DSLAM 201. The second high data rate connection 206 is a connection between the remote DSLAM 201 and another remote DSLAM or a connection between the remote DSLAM 201 and a network element (e.g., a router).

The multiple lower data rate connections (VDSL lines) 207 are telephone lines, i.e., twisted-pair copper telephone lines, in the preferred embodiment of the present invention. The multiple lower data rate connections 207 are connections between the remote DSLAM 201 and customer premises equipment (CPE) (not shown). The lower data rate connections may also be used for connecting two remote DSLAMs to each other. The lower data rate connections are 10/100 Mbit connections in the preferred embodiment of the present invention.

Even though in the preferred embodiment of the present invention there are used two high data rate connections, from which one of the high data rate connections is an optical connection and another high data rate connection is an electrical connection, the skilled man in the art understands that there may be used alternative solutions without departing from the scope of the present invention. For example, there may be used two (or more) optical connections and no electrical connection, or vice versa. Also the number of the high data rate connections may be higher than two (for example two optical connections and one electrical connection, from which one of the optical connections is connected to central office and the other high data rate connections are connected to other remote DSLAM(s)).

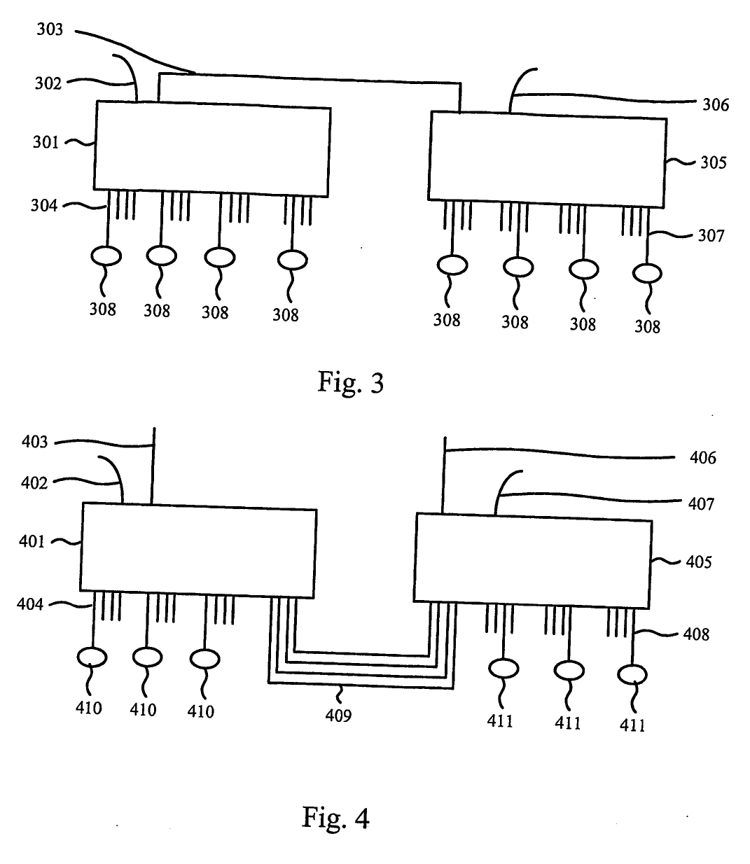

The connections between the remote DSLAM 201 and other devices of the VDSL system will be described more closely with reference to FIGS. 3 to 5.

The switch 202 forwards the packets (that are transmitted from the network to the customer premises equipment or another DSLAM and vice versa) between the high data rate connections 205 and 206 and the VDSL chipset 204. In the preferred embodiment of the present invention, the switch 202 is a Layer 2 and Layer 3 switch, which integrates multiple (e.g., 24) lower data rate (e.g., 10/100 Mbit) ports and two (the number depending on the number of high data rate connections) higher data rate (e.g., 10/100/1000 Mbit) ports. The two higher data rate ports interface to external physical layer device (optical and electrical connections) via GMII (Gigabit Media Independent Interface) or TBI (Ten Bit Interface) supporting both copper and fiber media. The switch 202 provides multiple (i.e., the same amount as the lower data rate ports) MACs (Media Access Controllers), which interface to external physical layer device (i.e., VDSL chipset 204) via SMII (Serial Media Independent Interface). The switch 202 further interfaces with the CPU 203 via a PCI Peripheral Component Interconnect) bus or other suitable interface. The switch may further comprise (or be connected to) one or several memory elements (via suitable buses).

The CPU 203 interfaces the switch 202 and the VDSL chipset 204 via a PCI bus (or other suitable interface). The CPU 203 further interfaces a memory (e.g., SDRAM (Synchronous Dynamic Random Access Memory) via suitable bus (e.g., a local bus). The CPU 203 may also interface other memories and/or monitoring devices implemented to the remote DSLAM 201.

The VDSL chipset 204 may include e.g., the following elements: two PTM (Packet Transfer Mode) framers, four BMEs (Burst Mode Engines), eight AFEs (Analog Front Ends), sixteen IFEs (Integrated Front Ends), and high pass and low pass filters. The functioning (and also the kinds) of the VDSL chipset 204 is well known to the person skilled in the art, and therefore, not described in further details herein. The preferred embodiment of the present invention implements a DMT (Discrete Multi Tone) modeling and ReedSolomon FEC (Forward Error Correction).

FIG. 3 shows an embodiment of the present invention, in which two remote DSLAMs are connected to each other via high data rate connection. The first remote DSLAM 301 has two high data rate connections 302 and 303 and multiple lower data rate connections 304. The second remote DSLAM 305 is connected to the first remote DSLAM via a high rate connection 303. The second remote DSLAM also has another high data rate connection 306 and multiple lower data rate connections 307.

In the first embodiment, the connection 303 between the first remote DSLAM 301 and the second remote DSLAM 305 is electrical connection capable of transmitting the data on Gbit rate. In this embodiment, the first remote DSLAM 301 has another high data rate connection 302, which is an optical fiber capable of transmitting the data on Gbit rate. The second remote DSLAM 305 has corresponding high data rate connection (optical fiber) 306. The high data rate connections 302 and 306 may be connected to e.g., central office of the DSL service provider or to still another remote DSLAM (not shown).

The first remote DSLAM 301 has further lower data rate connections 304 for connecting the CPEs (Customer Premises Equipment) 308 to the first remote DSLAM 301. The lower data rate connections 304 are twisted-pair copper telephone lines. The second remote DSLAM 305 has corresponding twisted-pair copper telephone lines 307 for connecting the CPEs 309 to the second remote DSLAM 305.

Even though there is shown 16 twisted-pair copper telephone lines between the first remote DSLAM 301 and the CPEs 308, the number of the twisted-pair copper telephone lines is dependent from the size (i.e., the number of connections) of the first remote DSLAM 301 and the number of subscribers connected. The DSLAM may also be designed to provide 12 or 24 connections to the CPEs.

In the second embodiment according to the concept of the present invention as shown in FIG. 3, the high data rate connection 303 is optical fiber. In this case the high data rate connections 302 and 306 may be connected e.g., to a node in the data network (not shown) or to another DSLAM(s).

The need for this kind of solution may arise when possible new customer would like to become subscribers of the service and there is no capacity available in the present remote DSLAM. In prior art solutions, the service provider should have inserted another remote DSLAM next to the first remote DSLAM and provide an optical fiber connection from the central office to the new remote DSLAM. Contrary to the prior art solutions, the present invention provides a solution in which a new remote DSLAM can be provided to serve new subscribers when the capacity of the first remote DSLAM is not sufficient.

Also by chaining the remote DSLAMs in parallel, the service provider may provide full service network capacity for subscribers in wider area for lower costs per subscriber (than in the prior art solutions), according to the maximum lengths of the connections (without lowering the data rates of the DSL service). The maximum lengths for providing full service network quality to subscribers are about 10 km (kilometers) for optical fiber (providing Gbit transmission data rate), and 150 meters for electrical wire (providing Gbit transmission data rate).

FIG. 4 shows an embodiment of the present invention, in which two remote DSLAMs are connected to each other via lower data rate connection. In this embodiment of the present invention, the first remote DSLAM 401 has two high data rate connections 402 and 403 via which the first remote DSLAM 401 may be connected to the service provider, the data network, or to other remote DSLAM(s). The second remote DSLAM 405 has corresponding high data rate connections 406 and 407. The DSLAMs 401 and 405 may also have additional high data rate connections (e.g., DSLAM 401 having three optical connections and DSLAM 405 having one optical connection and two electrical connections). In FIG. 4, the first remote DSLAM 401 further has lower data rate connections (i.e., twisted-pair copper telephone lines) 404 via which the first remote DSLAM 401 is connected to the CPEs 410. The corresponding connection between the second remote DSLAM 405 and the CPEs 411 is established via the lower data rate connections (i.e., twisted-pair copper telephone lines) 408.

As shown in FIG. 4, the first remote DSLAM 401 is connected to the second remote DSLAM 405 (or vice versa) via one or several lower data rate connections 409. The data transmission capacity will be lower in this solution than when the first remote DSLAM 401 would be connected to the second remote DSLAM 405 through optical fiber or electrical connection, but the transmission data rate between the first remote DSLAM 401 and the second remote DSLAM 405 is still on the level of around 100 Mbit. This transmission data rate is sufficient to provide high speed connection to some subscribers. The maximum length of the connection (over the twisted-pair copper telephone line) is about 500 meters without lowering the transmission data rate of the DSL service.

In case the first remote DSLAM 401 is connected to central office via optical connection (or alternatively to a data network via electrical connection) and to the second remote DSLAM 405 via twisted-pair copper telephone line(s) and the second remote DSLAM 405 is further connected to another remote DSLAM (not shown) via optical connection or electrical connection, the full capacity of the high data rate connection is not implemented in this latter data transmission procedure. This due to the fact that the twisted-pair copper telephone line(s) connection is capable of only transferring data at the rate of 100 Mbits.

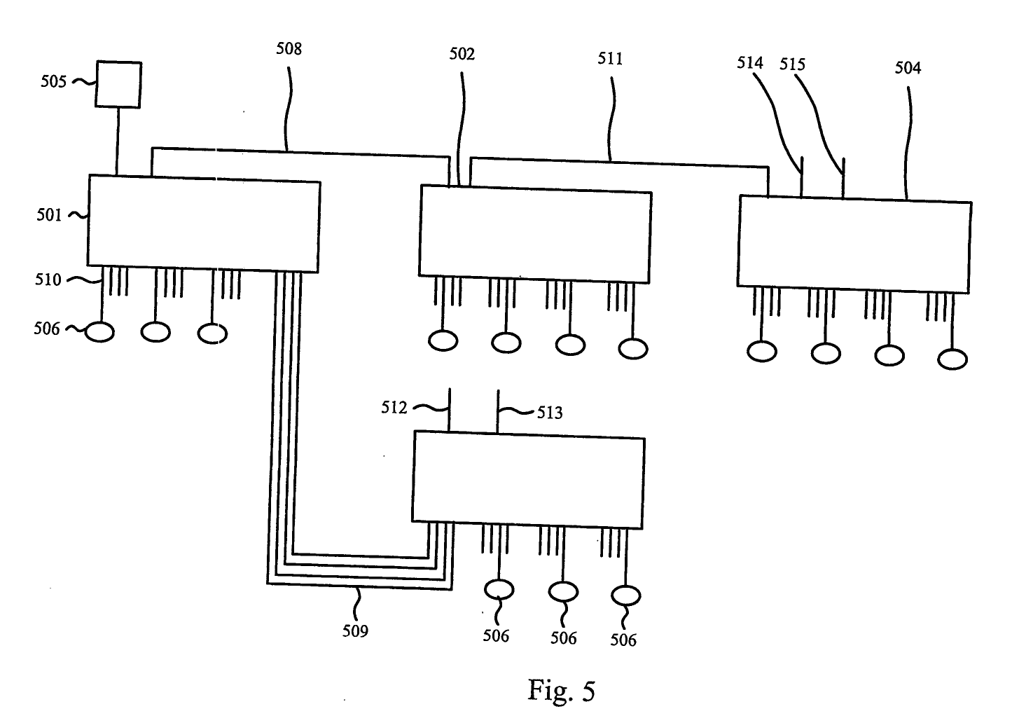

FIG. 5 shows one embodiment of the present invention. FIG. 5 shows different ways to connect two DSLAMs to each other. In FIG. 5, there is shown four remote DSLAMs 501, 502, 503, and 504, a central office 505, and several CPEs 506.

The first remote DSLAM 501 is connected to the central office via an optical connection (or fiber) 507. The first remote DSLAM 501 is further connected to the second remote DSLAM 502 via electrical connection 508 (alternatively the connection 508 may be optical connection), and to the third remote DSLAM 503 via twisted-pair copper telephone lines 509. The first remote DSLAM 501 is also connected to multiple CPEs 506 via respective twisted-pair copper telephone lines 510.

Like the first remote DSLAM 501, the second remote DSLAM 502 and the third remote DSLAM 503 are connected via respective twisted-pair copper telephone lines to the respective CPEs of the subscribers. The second remote DSLAM 502 is further connected to the fourth remote DSLAM 504 via an optical connection 511.

There is also shown in FIG. 5, an optical connection 512 and an electrical connection 513 of the third remote DSLAM 503, and an electrical connection 514 and another high data rate connection 515 (which may be an optical connection or an electrical connection) of the fourth remote DSLAM 504. Via the electrical connections 513 and 514, the third remote DSLAM 503 and the fourth remote DSLAM 504, respectively, may be connected to a further remote DSLAM or to a data network node (not shown). Via the optical connection 512 of the third remote DSLAM 503, it may be connected to a further remote DSLAM.

It will be appreciated by the skilled person in the art that various modifications may be made to the above-described embodiments without departing from the scope of the present invention, as disclosed in the appended claims. For example, there may be used two (or more) optical connections and no electrical connection (or vice versa) in the DSLAMs. Also the number of the high data rate connections may be higher than two (for example two optical connections and one electrical connection, or three optical connections and no electrical connections, from which one of the optical connections is connected to central office and the other high data rate connections are connected to other remote DSLAM(s)).

Also the DSL chipsets may vary. For example a DSL chipset may include e.g., the following elements: one PTM (Packet Transfer Mode) framers, two BMEs (Burst Mode Engines), four AFEs (Analog Front Ends), eight IFEs (Integrated Front Ends), and high pass and low pass filters. The elements (and the number of the elements) of the chipsets varies according to the chipset manufacturers.

1. A remote digital subscriber line access multiplexer (DSLAM) comprising:
means for connecting the remote DSLAM to a device through a first connection;
means for processing received data in the remote DSLAM; and
means for connecting the remote DSLAM to a DSLAM through a second connection.

2. A remote DSLAM according to claim 1, wherein the remote DSLAM further comprises a third connection for connecting to a remote DSLAM.

3. A remote DSLAM according to claim 1, wherein the device is a central office, a data network node, another remote DSLAM, or a customer premises equipment.

4. A remote DSLAM according to claim 1, wherein the DSLAM is a remote DSLAM.

5. A remote DSLAM according to claim 1, wherein. the first and the third connections are high data rate connections, which are optical connections or electrical connections.

6. A remote DSLAM according to claim 1, wherein the second connection is a twisted-pair copper telephone line connection, an optical connection, or an electrical connection.

7. A remote DSLAM according to claim 1, wherein the means for processing the received data comprises a switch, a CPU (Central Processing Unit), and a DSL chipset.

8. A DSL (Digital Subscriber Line) system providing data network services to customers, the DSL system comprising:
a central office;
a first remote DSLAM (Digital Subscriber Line Access Multiplexer) connected to the central office via a first high data rate connection;
a second remote DSLAM Connected to the first remote DSLAM via a second high data rate connection or lower data rate connection.

9. A DSL system according to claim 8, wherein the first high data rate connection is an optical connection.

10. A DSL system according to claim 8, wherein the second high data rate connection is an optical connection or an electrical connection.

11. A DSL system according to claim 8, wherein the lower data rate connection is a twisted-pair copper telephone line connection.

12. A DSL system according to claim 8, wherein the second remote DSLAM is further connected to a third remote DSLAM via an optical connection, an electrical connection, or a twisted-pair copper telephone line connection.

13. A DSL system according to claim 8, wherein the first remote DSLAM and the second remote DSLAM provides data to customers via twisted-pair copper telephone line connection.

14. A DSL (Digital Subscriber Line) system providing data network services to customers, the DSL system comprising:
a data network node;
a first remote DSLAM (Digital Subscriber Line Access Multiplexer) connected to the data network node via a first high data rate connection;
a second remote DSLAM connected to the first remote DSLAM via a second high data rate connection or lower data rate connection.

15. A DSL system according to claim 14, wherein the first high data rate connection is an electrical connection.

16. A DSL system according to claim 14, wherein the second high data rate connection is an optical connection or an electrical connection, and the lower data rate connection is a twisted-pair copper telephone line connection.

17. A DSL system according to claim 14, wherein the second remote DSLAM is further connected to a third remote DSLAM via an optical connection, an electrical connection, or a twisted-pair copper telephone line connection.

18. A DSL system according to claim 14, wherein the data network node is a router.
